(19) United States
(12) Patent Application Publication
(10) Pub. No.: US 2025/0003822 A1
(43) Pub. Date: Jan. 2, 2025

(54) ASSEMBLY OF A FIELD DEVICE FOR DETERMINING OR MONITORING A PHYSICAL OR CHEMICAL PROCESS VARIABLE

(71) Applicant: Endress+Hauser SE+Co. KG, Maulburg (DE)

(72) Inventors: Dietmar Leuthner, Weil am Rhein (DE); Sergey Lopatin, Lörrach (DE); Igor Getman, Lörrach (DE)

(21) Appl. No.: 18/709,699

(22) PCT Filed: Sep. 27, 2022
(86) PCT No.: PCT/EP2022/076769

§ 371 Date: May 13, 2024

(30) Foreign Application Priority Data
Nov. 12, 2021 (DE) 10 2021 129 594.7

(51) Int. Cl. G01L 19/06

(52) U.S. Cl. CPC G01L 19/0645

(57) ABSTRACT

Assembly of a field device for determining or monitoring a physical or chemical process variable of a medium in automation technology, wherein the assembly comprises at least a first component and a second component, which are joined to one another in a connecting region, and wherein, at least in a subregion which in the installed state of the field device is in contact with the medium, at least the second component consists completely of a material selected from the group comprising copper, a silver alloy or a copper alloy with the exception of a nickel-copper alloy.

The invention relates to an assembly of a field device for determining or monitoring a physical or chemical process variable of a medium in automation technology, and to a use of copper, a silver alloy, or a copper alloy, excluding a nickel-copper alloy as a measuring or separating diaphragm for a diaphragm seal or a sensor assembly.

In automation systems, in particular in process automation systems, field devices serving to capture and/or modify process variables are used in many instances. Sensors that are integrated in, for example, filling-level measuring devices, flow meters, pressure and temperature measuring devices, pH-redox potential meters, conductivity meters, etc., are used for capturing the respective process variables, such as fill level, flow rate, pressure, temperature, pH value, redox potential and/or conductivity. Actuators, such as, for example, valves or pumps, are used to influence process variables. The flow rate of a fluid in a pipeline section or a fill-level in a container can thus be altered by means of actuators. In principle, all devices that are process oriented and that supply or process process-relevant information are referred to as field devices. In connection with the invention, field devices are also understood to be remote I/Os, radio adapters and general devices that are arranged at the field level. A variety of such field devices is manufactured and marketed by the Endress+Hauser company.

In order to capture pressures of a process medium, so-called diaphragm seals are often used which have a housing body on which a separating diaphragm is fastened in a pressure-tight manner between the housing body and the separating diaphragm by forming a hydraulic chamber assembly filled with a pressure transfer fluid, wherein a hydraulic path extends through the housing body in order to transmit the pressure of a process medium present at the separating diaphragm.

The pressure transfer fluid enclosed in the hydraulic chamber assembly, which usually comprises an oil, causes a pressure that is applied at the side of the separating diaphragm facing the process medium to be guided to a pressure sensor element for detecting a pressure measurement value. To ensure optimal operation of the diaphragm seal over a long service life of several years up to a few decades, it is important here that the volume within the diaphragm seal should not significantly change, since otherwise a falsification of the pressure to be transmitted and thus of the pressure measurement value would take place.

Insofar as such a falsification is caused by hydrogen forming in the interior or diffused in from the outside, for example, in the form of hydrogen molecules and/or hydrogen atoms, it is known that precautions are taken in order to reduce such falsification.

For example, DE 10 2013 110 968 A1 proposes a hydrogen absorption material which is placed in the enclosed pressure transfer fluid so that hydrogen atoms are absorbed.

It is also known that, in order to limit the diffusion, the diaphragm is additionally coated. Usually, these are galvanically deposited gold layers or gold-rhodium layers. Galvanic layer thicknesses of up to 40 μm (micrometers) are necessary for efficient reduction of the diffusion. However, disadvantages of this variant are the relatively high costs due to a relatively thick gold layer, a possible negative change in the mechanical properties of the original separating diaphragm due to the relatively thick gold layer and bimetallic effects with temperature changes.

The object of the invention is to remedy this.

The object is achieved according to the invention by the assembly according to claim 1 and the field device according to claim 9.

The assembly of a field device according to the invention for determining or monitoring a physical or chemical process variable of a medium in automation technology comprises at least a first component and a second component which are joined together in a connecting region, and wherein, at least in a subregion which is in contact with the medium in the installed state of the field device, at least the second component consists completely of a material selected from the group comprising copper, a silver alloy, or a copper alloy with the exception of a nickel-copper alloy.

According to the invention, an assembly is proposed in which the second component, which may, for example, be a measuring or separating diaphragm, consists exclusively of a material selected from the group comprising copper, a silver alloy, or a copper alloy with the exception of a nickel-copper alloy. This means that the second component is designed as a solid component which consists of one of the materials mentioned, for example, a solid measuring or separating diaphragm made of one of the materials. By forming the second component as a solid component from one of the materials mentioned, the component has a high resistance to the ingress of hydrogen.

An advantageous embodiment of the assembly according to the invention provides that the copper alloy comprises a copper-beryllium, a copper-tin, or a copper-zinc alloy and/or the silver alloy a silver-copper, a silver-nickel, a silver-manganese, or a silver-copper-nickel alloy.

Another advantageous embodiment of the assembly according to the invention provides that the two components are joined to one another by soldering or gluing.

Yet a further advantageous embodiment of the assembly according to the invention provides that the assembly comprises a third component consisting of a different material of the group comprising copper, a silver alloy, or a copper alloy with the exception of a nickel-copper alloy.

A further advantageous embodiment of the assembly according to the invention provides that the second component, which in a subregion consists of a material selected from the group comprising copper, the silver alloy, or the copper alloy, with the exception of a nickel-copper alloy, and the third component each represent a single round blank which are joined to form a common round blank by rolling.

A further advantageous embodiment of the assembly according to the invention provides that the assembly is a diaphragm seal or sensor body for determining and/or monitoring a pressure of the medium, wherein the second component is a measuring or separating diaphragm which is in contact with the medium and wherein the first component is a diaphragm seal body or sensor body consisting of a metallic material, wherein the measuring or separating diaphragm and the metallic diaphragm seal body are joined together.

A further advantageous embodiment of the assembly according to the invention provides that the second and third components together form the measuring or separating diaphragm which is in contact with the medium.

The invention further relates to a use of copper, a silver alloy or a copper alloy with the exception of a nickel-copper alloy as the measuring or separating diaphragm for a diaphragm seal or a sensor assembly.

The invention is explained in more detail on the basis of the following drawings. In the figures:

FIG. 1: shows a first exemplary embodiment of the assembly according to the invention;

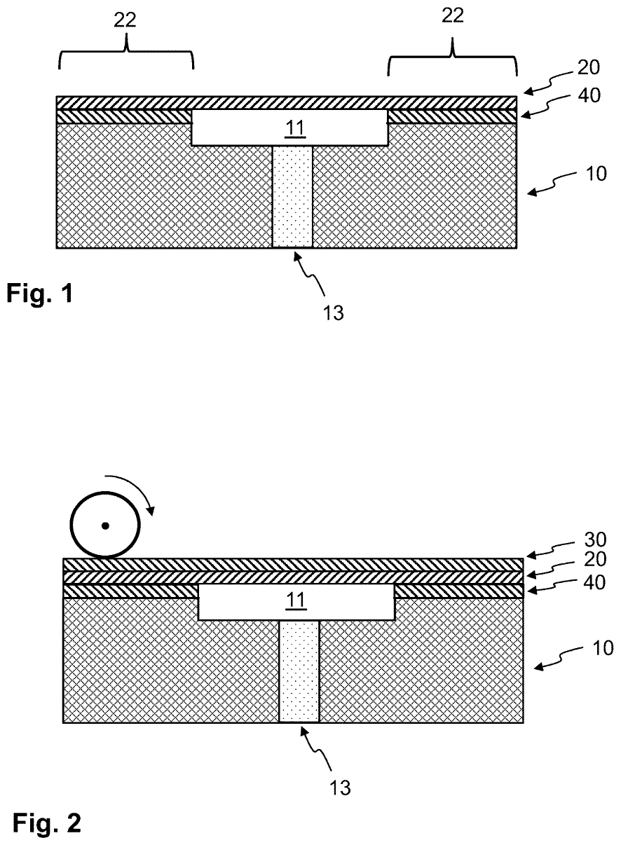

FIG. 2: shows a second exemplary embodiment of the assembly according to the invention; and

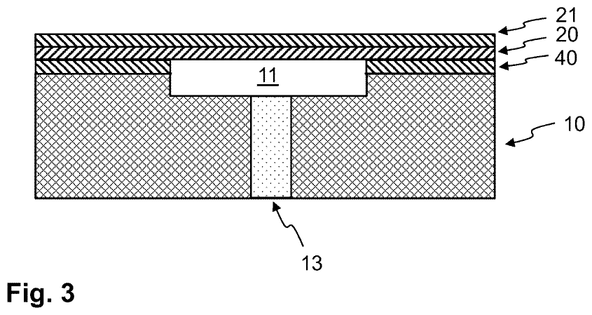

FIG. 3: shows a third exemplary embodiment of the assembly according to the invention.

FIG. 1 shows a first embodiment of the assembly according to the invention of a field device for determining or monitoring a physical or chemical process variable of a medium. A longitudinal section through an assembly according to the invention in the form of a diaphragm seal is shown. Nevertheless, it may also be a sensor assembly. The diaphragm seal comprises a preferably metallic diaphragm seal body as the first component 10 and a separating diaphragm as the second component 20 of the assembly according to the invention. The separating diaphragm 20 is joined in a pressure-tight manner along an edge region 22 via a circumferential joining or connecting region 40 with an end face of the diaphragm seal body or sensor body, so that a pressure chamber 11 is formed between the end face of the diaphragm seal body and the separating diaphragm. On a side of the chamber 11 facing away from the separating diaphragm 20, a diaphragm bed may also be produced in the diaphragm seal body 10, against which diaphragm bed the separating diaphragm 20 can rest in the event of an overload. The pressure chamber 11 may in turn be filled with a transfer fluid so that, in the joined state, a pressure of a process medium which is applied to the side of the separating diaphragm 20 facing away from the diaphragm seal body 10 is transmitted through the transfer fluid. The pressure can be transmitted, for example, via a hydraulic path 13 integrated into the diaphragm seal body 10 to a sensor element of the field device arranged offset from the diaphragm seal. The offset sensor element in turn determines a pressure value depending on the pressure transmitted via the hydraulic path 13 filled with the transfer fluid. In FIG. 1, the hydraulic path is indicated by way of example. Said hydraulic path is only necessary in the case of the diaphragm seal and not in the case of the sensor assembly, which is described below.

Alternatively, however, the assembly may also be a sensor assembly 10, 20 consisting of a sensor body 10 as a first component and a measuring diaphragm 20 as a second component. The sensor body 10 may be designed in such a way that, in the joined state, i.e., after the measuring diaphragm 20 has been joined circumferentially with the sensor body 10 in the edge region 22, a chamber 11 is produced. However, in contrast to the above-described example of the diaphragm seal, in the sensor assembly 10, 20 the chamber 11 is not filled with a pressure transfer fluid. Furthermore, in contrast to the diaphragm seal described above, the sensor assembly may be directly connected to the process with the measuring diaphragm 20 (flush mounting). A pressure value can also be determined via the pressure-dependent deflection of the measuring diaphragm 20 by the medium. In this case, the measuring diaphragm 20 also serves as a separating diaphragm which separates the field device to be connected from the medium.

According to the invention, the diaphragm (separating diaphragm in the case of the diaphragm seal and measuring diaphragm in the case of the sensor assembly) is formed exclusively from copper, a silver alloy, or a copper alloy, with the exception of a nickel-copper alloy (e.g., Monel). The diaphragm is thus designed or manufactured as a solid diaphragm of at least one of the materials mentioned. The following copper alloys have proven to be particularly advantageous materials here: a copper-beryllium, a copper-tin, or a copper-zinc alloy. With regard to the silver alloy, a silver-copper, a silver-nickel, a silver-manganese or a silver-copper-nickel alloy have proven to be particularly advantageous. The base body (diaphragm seal body in the case of the diaphragm seal and sensor body in the case of the sensor assembly) 10 can likewise be formed or manufactured from different corrosion-resistant materials depending on the application. For example, the main body 10 may consist of a high-alloy quality steel, such as a chromium-nickel steel, in particular 316L. Alternatively, however, the main body may also consist of a nickel-based alloy, such as, for example, AlloyC or a multiphase alloy, such as, for example, Duplex or the like.

For example, a diffusion soldering, a hard solder, or an adhesive method can be used to join the diaphragm 20 to the base body 10.

FIG. 2 shows a second exemplary embodiment of the assembly according to the invention. In this case, the structure of the assembly is the same as described above, the only difference is that the assembly has a third component 30. According to this embodiment, the second and third components 20, 30 are each designed as an individual round blank, which are joined to form a common round blank by rolling. The common round blank thus forms the measuring or separating diaphragm. The two individual round blanks are in this case each formed from one of the materials mentioned above.

FIG. 3 shows a further embodiment of the assembly according to the invention, which in turn is designed to be the same as the first embodiment. The only difference is that the assembly has a third component 30 which is applied to the second component 20 in the form of a coating. The coating is formed from another of the materials mentioned above. In principle, the third component 30 in the form of the coating does not have to be applied over the entire surface of the second component 20, but can also be present only in a region which is in contact with the medium in the installed state of the field device.

### LIST OF REFERENCE SIGNS

10 First component of the assembly, especially diaphragm seal or sensor body
11 Pressure chamber
13 Hydraulic path
20 Second component of the assembly, especially measuring or separating diaphragm
21 Coating
22 Edge region
30 Third component of the assembly
40 Connecting region

1-9. (canceled)

10. An assembly of a field device for determining or monitoring a physical or chemical process variable of a medium in automation technology, wherein the assembly comprises:
at least a first component and a second component, which are joined to one another in a connecting region, and wherein, at least in a subregion which is in contact with the medium in the installed state of the field device, at least the second component consists completely of a material selected from the group comprising copper, a silver alloy, or a copper alloy, with the exception of a nickel-copper alloy.

11. The assembly according to claim 10, wherein the copper alloy comprises a copper-beryllium, a copper-tin, or a copper-zinc alloy and/or the silver alloy a silver-copper, a silver-nickel, a silver-manganese, or a silver-copper-nickel alloy.

12. The assembly according to claim 10, wherein the two components are joined to one another by soldering or gluing.

13. The assembly according to claim 10, wherein the assembly comprises a third component consisting of a different material of the group comprising copper, the silver alloy, or the copper alloy, with the exception of a nickel-copper alloy.

14. The assembly according to claim 10, wherein the second component consisting in a subregion of a material selected from the group comprising copper, the silver alloy, or the copper alloy, with the exception of a nickel-copper alloy, and the third component each represent an individual round blank, which are joined to form a common round blank by rolling.

15. The assembly according to claim 10, wherein the second component consisting in a subregion of a material selected from the group comprising copper, the silver alloy, or the copper alloy, with the exception of a nickel-copper alloy, is coated with a coating at least in the region which in the installed state of the field device is in contact with the medium, wherein the coating consists of one of the other materials of the group comprising copper, the silver alloy, or the copper alloy, excluding a nickel-copper alloy.

16. The assembly according to claim 10, wherein the assembly is a diaphragm seal or a sensor assembly for determining and/or monitoring a pressure of the medium, wherein the second component is a measuring or separating diaphragm which is in contact with the medium and wherein the first component is a diaphragm seal body or sensor body consisting of a metallic material, wherein the measuring or separating diaphragm and the metallic diaphragm seal body or sensor body are joined together.

17. The assembly according to claim 13, wherein the second and third components together form the measuring or separating diaphragm which is in contact with the medium.

18. A use of copper, a silver alloy, or a copper alloy with the exception of a nickel-copper alloy as a measuring or separating diaphragm for a diaphragm seal or a sensor assembly.
